(19) United States
(12) Patent Application Publication
(10) Pub. No.: US 2019/0251490 A1
(43) Pub. Date: Aug. 15, 2019

(54) VIRTUAL PERSONAL ASSISTANT SYSTEMS AND METHODS

(71) Applicant: The Fin Exploration Company, San Francisco, CA (US)

(72) Inventors: Jeremiah Rogers, San Francisco, CA (US); Samuel Lessin, San Francisco, CA (US); Venkataramanan Iyer Nandagopal, San Francisco, CA (US)

(21) Appl. No.: 16/191,401

(22) Filed: Nov. 14, 2018

Related U.S. Application Data
(60) Provisional application No. 62/630,168, filed on Feb. 13, 2018.

(51) Int. Cl. G06Q 10/06; G06F 9/50; G06N 5/02

(52) U.S. Cl. CPC G06Q 10/06311; G06Q 10/06398; G06N 5/022; G06F 9/5027

(57) ABSTRACT

Methods and systems for managing agents and threads that form part of a virtual personal assistant system. One of the methods includes receiving a user request; associating a first agent with a triage state and a second agent with a queue state; providing a first thread associated with the user request to the first agent; receiving from the first agent at least one task to be performed to respond to the user request, the task forming part of the first thread; providing the first thread to the second agent, and removing the first thread from the second agent if the second agent does not act on the first thread according to a specified criteria, wherein an agent can only be in one of the triage state or the queue state at one time and an agent can work on a second thread only after stopping work on the first thread.

### CROSS-REFERENCE TO RELATED APPLICATIONS

This application claims the benefit under 35 U.S.C. § 119(e) of the filing date of U.S. patent application Ser. No. 62/630,168, for Virtual Personal Assistant Systems and Methods, which was filed on Feb. 13, 2018, and which is incorporated here by reference.

### BACKGROUND

This specification relates to computer-implemented systems and methods for managing agents that perform work for a virtual personal assistant system.

A user of a virtual personal assistant system can send a request for an action to be completed by the system. One challenge faced by a virtual personal assistant system, that includes human agents, is tracking the time that human agents spend working on various tasks associated with fulfilling a user's request.

### SUMMARY

One embodiment of a virtual personal assistant system can receive a user request in any of a variety of ways, e.g., by email, text, or voice command. In one embodiment, a virtual personal assistant system allows a user to make a request whenever the user desires regardless of whether a particular human assistant is available and the system will begin processing the user's request upon receipt increasing the usefulness of the system to the user. A virtual personal assistant system can include a plurality of human agents. Oftentimes, a virtual personal assistant system aims to record the time that a human agent spends working to fulfil a user request. One embodiment of a virtual personal assistant system described in this specification distinguishes between the time that the agent spends working and how the agent works (e.g., triaging a thread or working on a task that forms part of the thread), and the time the agent spends not working on a task, e.g., in a meeting on a different topic, on a break or at lunch.

One aspect provides a system including: one or more computers and one or more storage devices on which are stored instructions that are operable, when executed by the one or more computers, to cause the one or more computers to perform operations including: receiving a user request; associating a first agent with a triage state and a second agent with a queue state; providing a first thread associated with the user request to the first agent; receiving from the first agent at least one task to be performed to respond to the user request, the task forming part of the first thread; providing the first thread to the second agent, and removing the first thread from the second agent if the second agent does not act on the first thread according to a specified criteria, wherein an agent can only be in one of the triage state or the queue state at one time and an agent can work on a second thread only after stopping work on the first thread.

The operations can include separately, or in combination: moving an agent from a first state to a second offline state in response to inactivity by the agent for a specified period of time; and associating each of a plurality of agents with one of a plurality of states and where an agent can only be in one state at one time. The operations can include: receiving a work request from an agent in the queue state; determining if there is a thread to be provided to the agent in response to the work request; and moving the agent from the queue state to an on-deck state if there is no thread to provide to the agent. The operations can further include: receiving a first indication that the first agent associated with the triage state has provided a task to be performed to respond to the user request, the task forming part of the thread; awarding the first agent associated with the triage state a first type of credit in response to the first indication; receiving a second indication that the second agent associated with the queue state has worked on a task forming part of a thread; and awarding the second agent associated with the queue state a second type of credit, different from the first type of credit, in response to the second indication that the second agent has worked on the task forming part of the thread.

Another aspect described in this specification provides a system including: a state management engine configured to associate a first agent with a triage state and a second agent with a queue state and to associate an agent with only one of the triage state and the queue state at one time; a triage engine configured to receive a user request, to provide a thread associated with the user request to a first agent, and to receive from the first agent at least one task to be performed in order to respond to the user request, the task forming part of the thread; a queue engine configured to receive the thread from the triage engine, to provide the thread to the second agent, and to receive from the second agent an indication that the second agent has worked on a task forming part of the thread; and a thread management engine configured to provide a second thread to an agent only if the agent has provided an indication that the agent has stopped working on a first thread.

Yet another aspect described in this specification provides a computer-implemented method including: receiving a user request; determining that a first agent is in a triage state and that a second agent is in a queue state; providing a thread associated with the user request to the first agent; receiving from the first agent at least one task to be performed to respond to the user request, the task forming part of the thread; providing the thread to the second agent; and removing a thread from an agent if the agent does not act on the thread according to a specified criteria, wherein an agent can only be in one of the triage state or the queue state at one time and an agent cannot work on a second thread until after the agent's work on a first thread has stopped.

Removing a thread from an agent if the agent does not act on the thread according to a specified criteria can include removing a thread from an agent if the agent does not act on the thread within a specified period of time. In one embodiment, the work on a thread has stopped when the agent working on the thread has indicated completion of the work and/or when the agent working on the thread has requested a pause of work on the thread.

A method can include moving an agent from a first state to a second offline state in response to inactivity by the agent for a specified period of time. The method can include associating each of a plurality of agents with one of a plurality of states and allowing an agent to be in only one state at one time. The plurality of states can include a triage state, a queue state, an on-deck state, a project state, a lobby state, and a meeting state.

A method can include receiving a work request from an agent; determining if there is a thread to be provided to the agent in response to the work request; and moving the agent from the queue state to an on-deck state if there is no thread to provide to the agent. A method can include: receiving a first indication that the first agent associated with the triage state provided a task to be performed to respond to the user request, the task forming part of the thread; awarding the first agent associated with the triage state a first type of credit in response to the first indication; receiving a second indication that the second agent associated with the queue state has worked on a task forming part of a thread; and awarding the second agent associated with the queue state a second type of credit, different from the first type of credit, in response to the second indication that the second agent has worked on the task forming part of the thread.

A method can include: determining an agent productivity goal; and determining, for an agent, a percentage of the agent productivity goal reached by the agent. Determining the agent productivity goal can include determining a number of credits awarded to an agent, the duration of time in which the agent is associated with a state, the number of tasks worked on by the agent, and the number of threads provided to the agent.

In one embodiment, a primary agent cannot work on a thread that has been provided to a secondary agent while the secondary agent is working on the thread unless the primary agent is a higher priority agent than the secondary agent. In one embodiment, the primary and secondary agents are the same as the first and second agents, respectively.

Another aspect provide a computer-implemented method including: receiving a user request; associating a first agent with a triage state and a second agent with a queue state; providing a thread associated with the user request to the first agent; receiving from the first agent at least one task to be performed to respond to the user request, the task forming part of the thread; providing the thread to the second agent, and removing a thread from an agent if the agent does not act on a thread according to a specified criteria, wherein an agent can work on a second thread only after the agent no longer has the ability to work on the first thread in real-time.

The subject matter described in this specification can be implemented in particular embodiments so as to realize one or more of the following advantages. The subject matter described in this specification can be implemented in particular embodiments so as to realize one or more of the following advantages. An agent of the virtual personal assistant system is able to work on one user request at a time. In addition, once the agent receives the user request from the system, other agents are not permitted to work on the user request while the agent is working on the user request. These features improve the virtual personal assistant system by ensuring there is no duplication of work and that work can be tracked accurately. Tracking work accurately allows for better performance management. These features also improve the efficiency of the virtual personal assistant system, with regard to how quickly and accurately it is able to complete user requests, by ensuring every agent focuses all of his or her attention on completing a single user request at a time. Other advantages include 1) building a data-set which allows prediction regarding the time to complete similar tasks, and 2) early warning when a task is not being completed correctly by associating each action taken to a specific work request.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram of the components of an exemplary agent management system.

FIG. 2 is a diagram of the states of the agent management system according to one embodiment.

FIG. 3 is a flowchart for an exemplary method of managing work by the agent management system.

FIG. 4 is a flowchart for an exemplary method of awarding credit to an agent of the agent management system.

### DETAILED DESCRIPTION

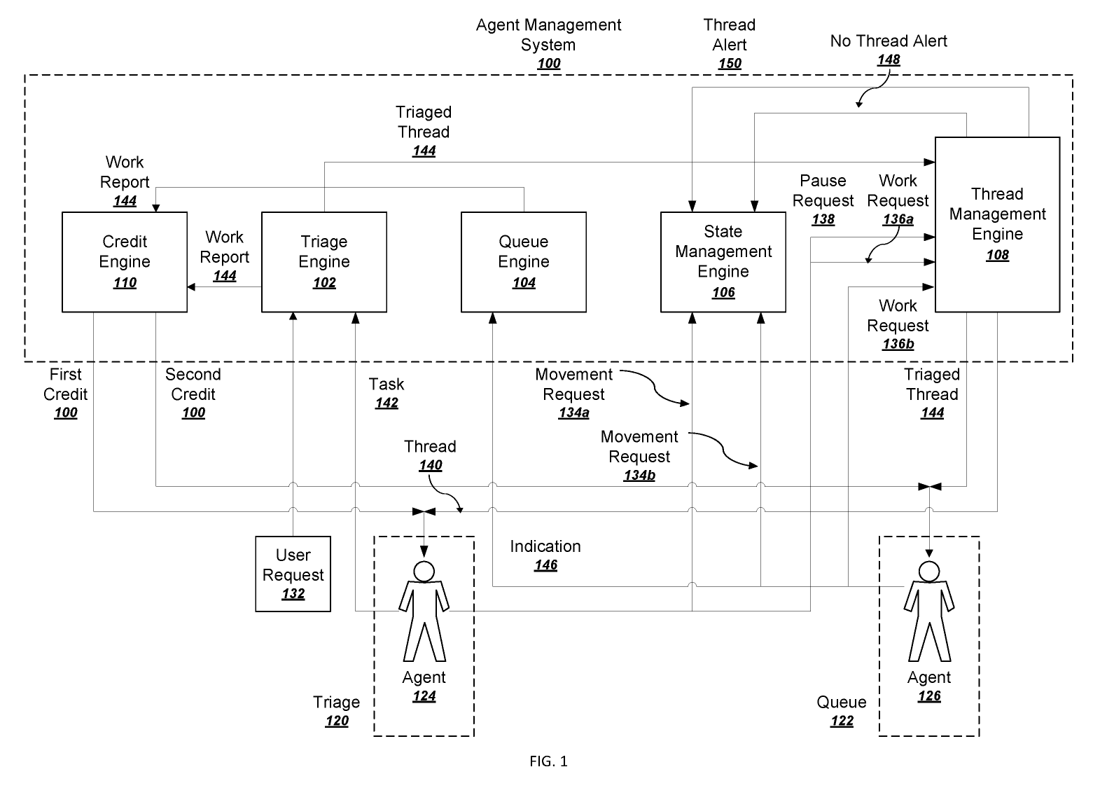

FIG. 1 is a diagram of the components of an exemplary agent management system 100. With reference to FIG. 1, one of the roles of an agent is to respond to a user request, such as user request 132, when the request is sent to agent management system 100. User request 132 can take many forms such as a request for a restaurant reservation, a purchase of an item, a gift or tickets, or the arrangement and calendaring of a meeting.

FIG. 1 includes a triage engine 102, a queue engine 104, a state management engine 106, a thread management engine 108, and a credit engine 110. User request 132 can be processed by triage engine 102 into a format called a thread. Before being triaged, a thread can be formatted to include information such as the content of the user request and the time at which the user sent the request. The thread is then “triaged” to determine what tasks need to be performed to respond to the user's request. An agent of the system can triage threads. For example, the triaging agent can identify one or more tasks to be added to a thread. A triaging agent can add tasks to at most one thread at a time. In one embodiment the triage engine 102 can assign some threads to a human agent for triage and can automatically triage other threads.

After being triaged, a thread can include one or more tasks, i.e., actions that an agent can perform to respond to the user request and, in certain embodiments, a priority associated with the user request. A triaged thread, such as triaged thread 144, can then be sent from triage engine 102 to thread management engine 108, which is configured to store threads.

Although FIG. 1 shows two agents, agent management system 100 can manage a large number of agents. Each agent interacting with agent management system 100 is associated with a state. Agent management system 100 includes a plurality of states, such as a triage state 120 and a queue state 122, both shown in FIG. 1. Agent management system 100 can also include more states such as an offline state 202, a lobby state 204, a meeting state 206, a project state 208, a break state 210, a lunch state 212, and an on deck state 214, which are described in more detail below. In embodiments described in this specification, each agent managed by agent management system 100 is in only one state at any one time.

Each state is associated with one or more rules that govern the work that can be done by an agent in that state. Certain states permit an agent to work on threads, while other states do not permit an agent to work on threads. For example, triage state 120, queue state 122, meeting state 206, project state 208, and on deck state 214 all permit an agent to work on threads. However, offline state 202, lobby state 204, break state 210, and lunch state 212 do not permit an agent to work on threads.

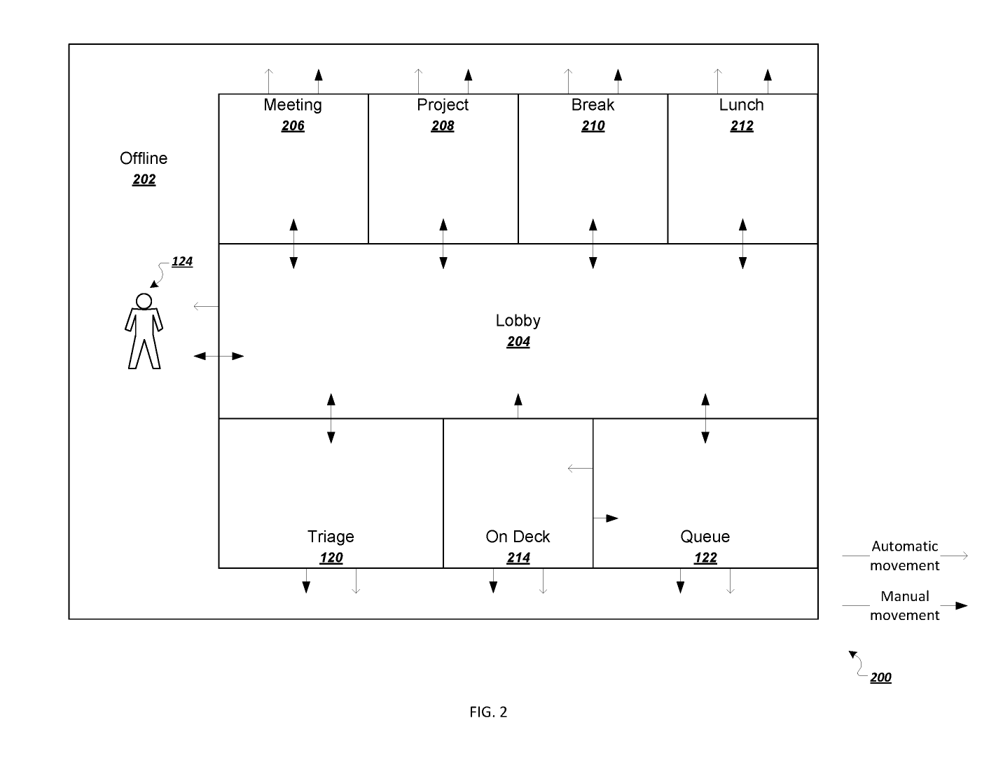

The one or more rules associated with each state also govern the movements of the one or more agents into and out of the state. Agent management system 100 includes state management engine 106, which is configured to monitor which state each agent is in and ensure that each agent is associated with exactly one state. An agent can choose to move manually from one state to another in accordance with the rules of the relevant states. For example, with reference to FIGS. 1 and 2, while in lobby state 204, agent 124 can send a movement request 134a to state management engine 106 that represents a request to move to triage state 120. In response to movement request 134a, state management engine 106 can record agent 124 as no longer being in lobby state 204, and instead being in triage state 120. As another example, agent 126 can request to be moved to queue state 122 by sending a movement request 134b to state management engine 106. In response to movement request 134b, state management engine 106 can record agent 126 as being in queue state 122.

In some cases, state management engine 106 rejects a movement request and does not record an agent as being in the state specified by the movement request. For example, an agent can only enter a so-called on deck state 214 from queue state 122, after requesting work from the agent management system 100 when there is no work available to provide in response to the request. In other words, an agent cannot enter on deck state 214 by sending a movement request. Therefore, a movement request to enter this state will be denied by state management engine 106.

An agent can also be moved from one state to another by state management engine 106 not as a result of a request from the agent in question. For example, if an agent is in queue state 122 for more than a threshold amount of time without engaging with a thread, then state management engine 106 can move the agent from queue state 122 to offline state 202.

In certain embodiments, not only can an agent manually move from one state to another by sending a movement request, the agent can also move from one state to another by sending a work request to thread management engine 108. For example, although not shown in the figures, an agent in lobby state 204 can send a work request to thread management engine 108. If the thread management system has either a thread or a triaged thread, it can provide either one to the agent. For example, if thread management engine 108 has a thread (i.e., that has not been triaged) it can provide the thread to the agent in response to the work request. Thread management engine 108 can also indicate to state management engine 106 that the thread has been provided to the agent. In response to the indication, state management engine 106 can move the agent to triage state 120.

As previously mentioned, triage engine 102 is configured to receive a user request 132. However, in certain embodiments, a user request can be processed by the asset management system prior to being provided to the triage engine. Triage engine 102 is configured to process user request 132 into thread 140. After processing user request 132 into thread 140, triage engine 102 can send thread 140 to thread management engine 108.

Agent 124 in triage state 120 can send work request 136a to thread management engine 108. In response to receiving work request 136a from agent 124, thread management engine 108 can provide agent 124 with exclusive access to thread 140. Thread management engine 108 can also send thread 140 to triage engine 102, in anticipation of thread 140 being triaged. After receiving thread 140, agent 124 can identify one or more tasks, such as task 142, to be performed to complete the user request. Agent 124 can send task 142 to triage engine 102. The triage engine adds task 142 to thread 140. As a result of triaging, thread 140 becomes triaged thread 144, which includes task 142. Triage engine 102 can then send triaged thread 144 to thread management engine 108. Once thread 140 is triaged to become thread 144, agent 124 no longer has access to thread 140. Triaged thread 144 can then be provided to the same or different agent of agent management system 100 to be worked on further.

When thread 140 or triaged thread 144 is provided to an agent, it is “locked” meaning that the agent is granted exclusive access to the thread and the agent is said to have a lock on that thread. For example, when thread management engine 108 provides agent 124 with thread 140, agent 124 has the lock for thread 140. When agent 124 has this lock, only agent 124 can access thread 140. In other words, only agent 124 can provide triage engine 102 with task 142.

As another example, if agent 126 is provided with triaged thread 144, then that agent is granted exclusive access to triaged thread 144 during the time the agent has a lock on the thread. This means that only agent 126 can work on task 142 that forms part of triaged thread 144 while that agent has the lock on the thread.

As previously mentioned, in certain embodiments an agent can only actively work on one thread at a time. In other words, a thread can be referred to as locked when an agent has been assigned the thread. This means that an agent can be actively working on at most one locked thread at any time. Locks can also be associated with a type. In certain embodiments, types of locks include triage, conversation, and review; a thread with a triage lock can only be worked on by an agent in triage state 120 or queue state 122; and a thread with a conversation lock or review lock can only be worked on by an agent in triage state 120, queue state 122, meeting state 206, and project state 208.

Agent management system 100 can remove or “unlock” a locked thread (also referred to simply as a lock) from an agent if the agent is inactive for more than a threshold period of time. The threshold period can vary depending on the type of lock. In one embodiment, a triage lock is removed from an agent after five minutes of inactivity, while a conversation lock and a review lock can be removed from an agent after 15 minutes of inactivity. In other embodiments the threshold period can range from 1 minute to 30 minutes.

In one embodiment, thread management engine 108 can remove a lock from an agent. For example, thread management engine 108 can remove a lock from an agent if the agent is inactive for more than a threshold period. To determine how long the agent has been inactive, thread management engine 108 records the time elapsed since an agent has worked on a locked thread. Working on a locked thread can include inputting data into the system that reflects progress in responding to the user request.

In another example, thread management engine 108 can provide a conversation lock to agent 126 in queue state 122. After receiving the conversation lock, if the agent 126 is inactive for more than the threshold period, thread management engine 108 will unlock the conversation lock and in response to a work request from an alternative agent, thread management engine 108 can provide the unlocked thread to the alternative agent in queue state 122.

In one embodiment, an agent that has a conversation or review lock can pause the lock. In certain embodiments, while an agent can have at most one active lock at a time, an agent can have more than one paused lock. An agent might pause a first locked thread or lock to allow the agent to work on a higher priority thread that the agent became aware of after starting work on the first locked thread. In one embodiment, while conversation and review locks can be paused, triage locks cannot. An agent with a conversation or review lock can send a pause request to thread management engine 108. When thread management engine 108 receives a pause request, the engine can mark the corresponding lock as paused.

An agent with a paused thread can also un-pause the thread, to continue working on it. For example, an agent can pause a conversation thread and begin working on a high-priority triage thread. When the agent has finished working on the high-priority triage thread, the agent can then unlock the high-priority triage thread, so that the agent no longer has access to the high-priority triage thread. After unlocking the high-priority triage thread, the agent can unpause the prior conversation thread, and continue working on it. In one embodiment, if an agent unpauses the conversation thread before unlocking the triage thread, the system will automatically unlock the triage thread.

In one embodiment, receiving a triage thread can automatically pause a conversation or review thread. For example, an agent with a conversation or review thread can request a triage thread. When the agent receives the triage thread, the conversation or review thread that the agent has is automatically paused. Such a scenario might occur if an agent becomes aware of a high-priority triage thread after starting work on a conversation or review thread.

Just as work done by an agent in triage state 120 is sent to triage engine 102, work done by an agent in queue state 122 is sent to queue engine 104. Queue engine 104 is configured to receive one or more threads from triage engine 102 and to store the received threads.

As previously mentioned, after triaging thread 140 to form triaged thread 144, triage engine 102 can send triaged thread 144 to thread management engine 108. Agent 126 in queue state 122 can communicate a work request 136b to thread management engine 108. In response to work request 136b, thread management engine 108 can provide agent 126 with triaged thread 144 and as a result, the engine locks the thread. The agent can then work on task 142 that forms part of triaged thread 144. After performing task 142, agent 126 can send an indication 146 to queue engine 104.

If, for example, user request 132 corresponds to a dinner reservation request, then indication 146 can include a confirmation of a restaurant reservation, e.g., a confirmation number, time, date, and location of the restaurant. Indication 146 can also include a contact number and website for the restaurant. As another example, if user request 132 corresponds to a shopping request, then indication 146 can include a date, time, and description of a purchase along with a tracking number and vendor contact information.

Indication 146 can also include metadata related to the task. As an example, the metadata can include how long it took agent 126 to perform the task, the time that agent 126 performed the task, and the resources that agent 126 used to perform the task. When agent 126 transfers indication 146 to queue engine 104, the queue engine can indicate this to credit engine 110, via work report 144. In response, credit engine 110 awards a credit to agent 126.

Credit engine 110 can award a credit to an agent in response to an action performed by an agent. A credit can also be awarded based on other metrics such as, an amount of time an agent worked on a particular thread, an amount of time an agent spent in a certain state, the number of work requests an agent sent while in a certain state, the number of tasks worked on by an agent, and the number and type of each thread that an agent locked while in a certain state. These metrics, and the number of credits awarded to one or more agents, can be used to determine a productivity goal for certain agents. Agent management system 100 can use the number of credits an agent has to determine the agent's progress towards his or her productivity goal.

In certain embodiments, not only can thread management engine 110 remove a locked thread from an agent, agents can also remove locked threads from each other. For example, a managing agent may become aware of new information that modifies a request from a high-priority user. Such a managing agent can override a lock on a thread being worked on by agent 126. In such a situation, the managing agent, being a higher priority agent, can remove the thread from agent 126.

An exemplary agent management system can include more states than those discussed with regard to FIG. 1. In certain embodiments, an agent can enter and exit multiple states over a period of time but the agent exists in only in one state, e.g., a triage state or a queue state, at a particular time. FIG. 2 is a diagram of the states of an agent management system, such as agent management system 100. FIG. 2 includes agent 124, triage state 120, queue state 122, offline state 202, lobby state 204, meeting state 206, project state 208, break state 210, lunch state 212, and on deck state 214. FIG. 2 also shows an number of arrows, pointing from one state to another. An arrow indicates that an agent is able to move from one state, i.e., the state at the tail of the arrow, to another state, i.e., the state at the head of the arrow. The diagram includes two types of arrows to differentiate between two types of movements: automatic (as depicted by the thinner arrows) and manual (as depicted by the thicker arrows).

Agent management system 100 can move an agent between two states, for example, in response to determining that the agent has been inactive for longer than a threshold period of time. This specification refers to movements made by the agent management system 100 without a request by an agent or administrator as automatic. As illustrated by the arrows shown in FIG. 2, state management engine 106 can automatically move agent 124 to offline state 202 from triage state 120, queue state 122, meeting state 206, project state 208, break state 210, lunch state 212, lobby state 204, or on deck state 214. state management engine 106 can make these movements after determining that agent 124 has been inactive for more than a threshold period of time. In one embodiment, state management engine 106 can move an agent from triage state 120 to offline state 202 if the agent is in triage state 120 for more than a specified period of time (e.g., a period of between 10 minutes and 3 hours such as for example two hours) without requesting a thread on which to work. Also in this embodiment, state management engine 106 can move an agent from queue state 122 to offline state 202 if the agent is in queue state 122 for more than five minutes without requesting a thread on which to work. In other embodiments, the threshold period can be longer, e.g., 6-50 minutes.

Apart from being automatically moved by agent management system 100, an agent can also choose to move manually from one state to another. As illustrated by the arrows shown in FIG. 2, agent 124 can manually move to offline state 202 from triage state 120, queue state 122, lobby state 204, meeting state 206, project state 208, break state 210, lunch state 212, and on deck state 214. To perform a manual movement, agent 124 can send a movement request to state management engine 106, which can respond by associating agent 124 with the new state indicated by the movement request.

If an agent is the only agent in a state or one of few agents in a state, state management engine 106 can message the agent if the agent sends a movement request to leave the state. For example, agent 124 can be the only agent in triage state 120. If agent 124 sends a movement request to state management engine 106, then state management engine 106 can respond by alerting agent 124 that exiting triage state 120 would result in there being no or few agents in this state and in one embodiment, the state management engine 106 can prevent or delay the movement until the state management system 106 can locate a replacement or additional agents for that state. In one embodiment, the state management engine 106 may message potential agents that additional credits are available for agents who join the depleted state for a specified period of time or while the shortage lasts.

In one embodiment, before interacting with agent management system 100, an agent, such as agent 124, must log in to the system. Prior to logging in, agent 124 is in offline state 202. An agent in offline state 202 cannot request or receive threads, work on tasks, transfer indications, or be awarded credit. Once agent 124 logs in, the agent is moved from offline state 202 to lobby state 204. While in lobby state 204, agent 124 can also be logged out by agent management system 100. In this case, the agent is automatically moved from lobby state 204 to offline state 202. In one embodiment, when an agent is in lobby state 204, the agent cannot obtain a thread on which to work. As a result, the agent cannot work on any tasks.

An agent can enter meeting state 206 to indicate the agent is attending a meeting. While in meeting state 206, the agent can send a work request to thread management engine 110. The agent can also receive a thread from thread management engine 110 in response to the work request, work on a task associated with the thread, and return the result to the engine handling the thread, e.g., triage engine 102 or queue engine 104. Triage engine 102 or queue engine 104 can indicate the completion of the task associated with the thread to credit engine 110, e.g., through a work report. In turn, credit engine 110 can award the agent a credit for completing the work request. In this embodiment, because the agent completed the task while in meeting state 206, the credit awarded to the agent is different from the credit awarded to another agent that completed a task while in triage state 120 or queue state 122.

In this embodiment, state management engine 106 moves an agent from meeting state 206 to offline state 202 if the agent is inactive for more than a threshold period of four hours. In other embodiments, the threshold period can range from half an hour to four hours.

Just as an agent can move from lobby state 204 to meeting state 206, the agent can also move from lobby state 204 to project state 208. An agent can move to project state 208 to indicate that he or she is working on a project. Similar to being in meeting state 206, the agent can also request work, work on a task that makes up the thread, transfer an indication, and be awarded credit for completing the task. The credit awarded to the agent while in project state 208 is different from the credit awarded to another agent that completed work while in the triage state 120 or the queue state 122.

In one embodiment, state management engine 106 moves an agent from project state 208 to offline state 202 if the agent is inactive for more than a threshold period of four hours. In other embodiments, the threshold period can range from half an hour to four hours.

Agent 124 can also move from lobby state 204 to break state 210. agent 124 can move to break state 210 to indicate that the agent is taking a break. An agent in break state 210 cannot request or receive threads, work on tasks, transfer indications, or be awarded credit.

In this embodiment, state management engine 106 moves an agent from break state 210 to offline state 202 if the agent is inactive for more than a threshold period of 25 minutes. In other embodiments, the threshold period can range from 10 minutes to 60 minutes.

Agent 124 can also move from lobby state 204 to lunch state 212. agent 124 can move to lunch state 212 to indicate that he or she is eating lunch. An agent in lunch state 212 cannot request or receive threads, work on tasks, transfer indications, or be awarded credit.

In this embodiment, state management engine 106 moves an agent from lunch state 212 to offline state 202 if the agent is inactive for more than a threshold period of 80 minutes. In other embodiments, the threshold period can range from 30 minutes to 90 minutes.

In one embodiment, agent management system 100 can automatically move an agent from queue state 122 to on deck state 214 if the agent requests work when there is no work available. For example, when agent 124 is in queue state 122, the agent can send a work request to thread management engine 110. If thread management engine 110 does not have a thread to provide the agent, then thread management engine 110 can communicate this to state management engine 106 via a no thread alert 148. The information communicated to state management engine 106 via a no thread alert 148 can include the time agent 124 sent the work request and an identifier for the agent, i.e., to identify the agent as the agent that sent the work request. In response to the no thread alert 148, state management engine 106 can move the agent from the queue state 122 to on deck state 214.

While an agent is in on deck state 214, thread management engine 110 continuously checks to determine if a new thread has been received. If a new thread is received, then thread management engine 110 assigns the agent the new thread. Thread management engine 110 also sends a thread alert 150 to state management engine 106 to communicate that the agent has been assigned the new thread. In response to thread alert 150, state management engine 106 can move the agent from on deck state 214 to queue state 122.

In this embodiment, state management engine 106 moves an agent from on deck state 214 to offline state 202 if the agent is without a thread for more than a threshold period of one hour. In other embodiments, the threshold period can range from 30 minutes to 2 hours.

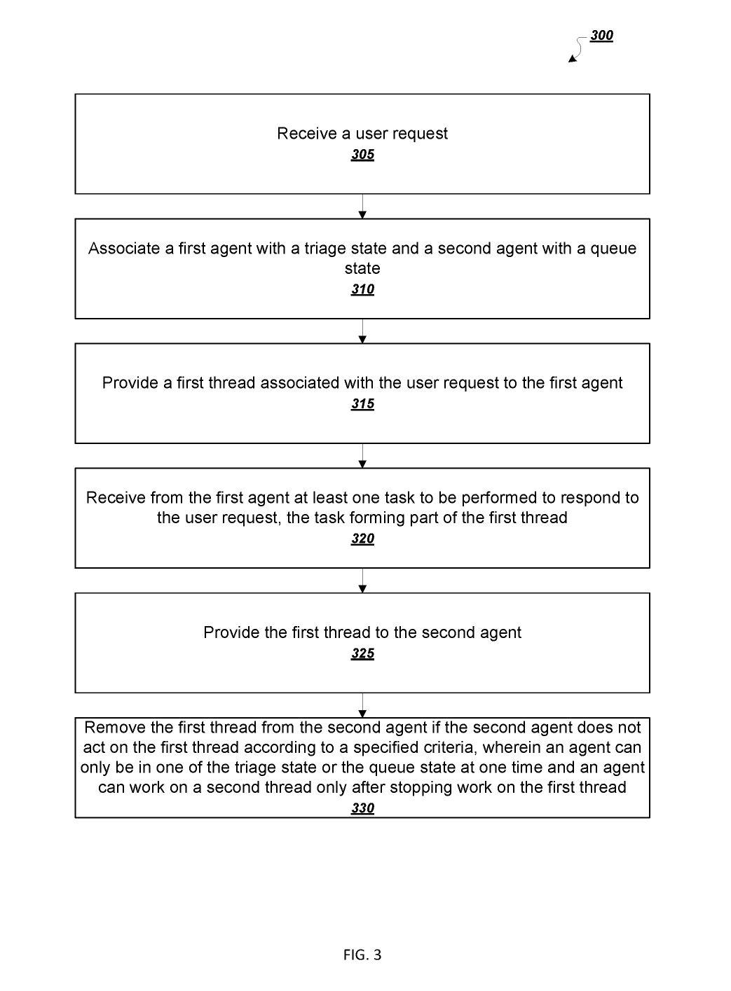

FIG. 3 is a flowchart for an exemplary method of managing work by an agent management system. When appropriately configured, the agent management system 100 can perform the example method.

The agent management system receives a user request (305). A user request corresponds to an action that a user wants to be performed by one or more agents of the agent management system. The user request is sent from a user to a thread management engine of the agent management system.

The agent management system associates a first agent with a triage state and a second agent with a queue state (310). The agent management system can include a state management engine that associates an agent with one of a plurality of states of the agent management system. The state management engine associates an agent with only one state at a time. The state management engine also keeps track of the state with which each agent is associated.

The agent management system can provide a first thread associated with the user request to the first agent (315). The thread management engine can provide a thread to the first agent. The thread includes information corresponding to the actions that the user wants performed by the one or more agents of the agent management system.

The agent management system receives from the first agent at least one task to be performed to respond to the user request, the task forming part of the first thread (320). The first agent identifies one or more tasks that can be performed by the one or more agents of the agent management system in order for these agents to complete the user request. The first agent sends the one or more tasks to the triage engine. The engine then triages the first thread such that the first thread includes the one or more tasks necessary to complete the user request associated with the thread.

The agent management system provides the first thread to the second agent (325). The thread management engine can provide the first thread, which has been triaged, to the second agent, in response to the second agent requesting work from the thread management engine. The thread management engine can also record the time in which it provides the triaged first thread to the second agent. Once the triaged first thread has been provided to the second agent, the thread management engine does not provide the triaged first thread to any other agent unless the second agent returns the triaged first thread or the triaged first thread is removed by another, higher priority agent or by the agent management system.

The agent management system removes the first thread from the second agent if the second agent does not act on the first thread according to a specified criteria, wherein an agent can only be in one of the triage state or the queue state at one time and an agent can work on a second thread only after stopping work on the first thread (330). The specified criteria can be a minimum allowable timespan for the second agent to have the triaged first thread, but not work on it. If the second agent does not work on the triaged first thread within the minimum allowable timespan, then the thread management engine can remove the triaged first thread from the second agent. Once the thread management engine removes the triaged first thread from the second agent, the thread can be provided to another agent in the queue state.

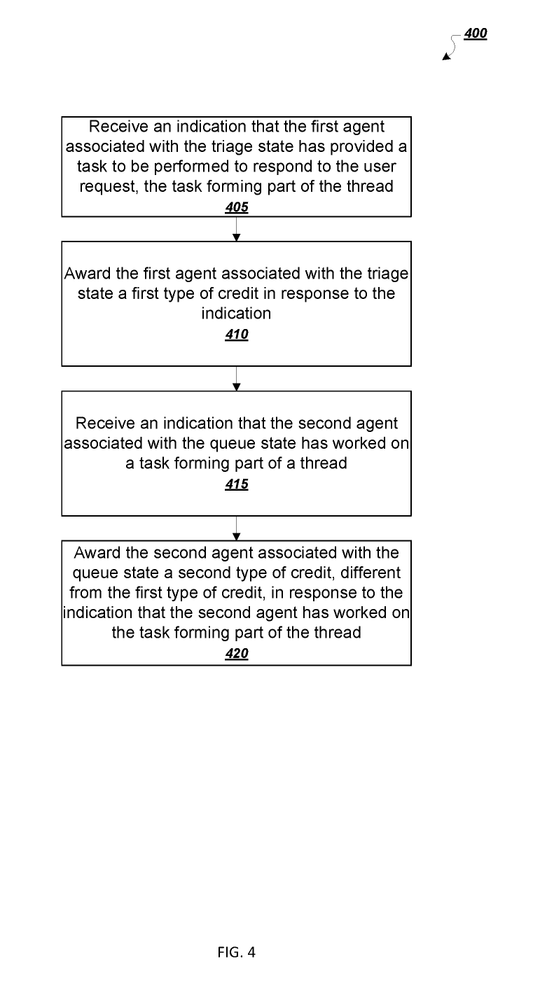

FIG. 4 is a flowchart for an exemplary method of awarding credit to an agent of an agent management system. When appropriately configured, the agent management system 100 can perform the example method.

The agent management system receives an indication that a first agent associated with a first state has worked on a task forming part of a triaged thread (405). For example, the first state can be a queue state. Correspondingly, a thread management engine can give the triaged thread to the first agent. When the first agent completes the task forming part of the triaged thread, the first agent sends an indication to the queue engine. As an example, the triaged thread can correspond to a user request for buying kitchen supplies from an online vendor. A triaging agent can triage the thread by adding tasks such as “search vendors A, B, and C for kitchen supplies” and “buy the kitchen supplies from the vendor offering the lowest price”. After receiving the triaged thread, the first agent can send an indication to the queue engine indicating that vendor A offered the lowest price for the kitchen supplies. The indication can further include the price of the kitchen supplies from each of the three vendors.

The agent management system awards the first agent associated with the triage state a first type of credit in response to the indication that the first agent has worked on the task forming part of the triaged thread (410). In response to receiving the indication, the agent management system can mark the corresponding task as completed, update the triaged thread to include the indication, and award the first agent a first type of credit. The first type of credit is indicative of the state in which the first agent completed the task.

The agent management system receives an indication that the second agent associated with a second state has worked on a task forming part of the triaged thread (415). Continuing the previous example, if the first agent stops working on the triaged thread after sending the indication, then the agent management system can provide the triaged thread to another agent, such as a second agent in a second state. For example, the second state can be a queue state. While in the queue state, the second agent can send a work request to the agent management system. In response to the work request, the agent management system can give the second agent the triaged thread that was previously worked on by the first agent.

As previously discussed, a task forming part of the triaged thread could be “buy the kitchen supplies from the vendor offering the lowest price”. The second user can determine, from the indication included in the triaged thread, that the vendor offering the lowest price is vendor A. To work on the request, the second agent can buy the kitchen supplies from vendor A, and provide an indication to indicate the purchase to the agent management system. For example, the indication can include a confirmation number for the purchase.

The agent management system awards the second agent associated with the queue state a second type of credit in response to the indication that the second agent has worked on the task forming part of the triaged thread (420). Following the previous example, the agent management system can receive the indication corresponding to the purchase of kitchen supplies from vendor A. In response, the system can award the second agent a second type of credit. Because the first agent and second agent were in different states when they worked on the triaged thread, each is awarded a different type of credit. For example, the second agent can receive the second type of credit because he or she worked on the triaged thread while in the queue state, as opposed to queue state, where the first agent worked on the triaged thread.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone, running a messaging application, and receiving responsive messages from the user in return.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a sub combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A system comprising:
one or more computers and one or more storage devices on which are stored instructions that are operable, when executed by the one or more computers, to cause the one or more computers to perform operations comprising:
receiving a user request;
associating a first agent with a triage state and a second agent with a queue state;
providing a first thread associated with the user request to the first agent;
receiving from the first agent at least one task to be performed to respond to the user request, the at least one task forming part of the first thread;
providing the first thread to the second agent, and
removing the first thread from the second agent if the second agent does not act on the first thread according to a specified criteria, wherein an agent can only be in one of the triage state or the queue state at one time and an agent can work on a second thread only after stopping work on the first thread.

2. The system of claim 1, wherein the operations further comprise moving an agent from a first state to a second offline state in response to inactivity by the agent for a specified period of time.

3. The system of claim 1 wherein the operations further comprise associating each of a plurality of agents with one of a plurality of states and where an agent can only be in one state at one time.

4. The system of claim 3 wherein the operations further comprise:
receiving a work request from an agent in the queue state;
determining if there is a thread to be provided to the agent in response to the work request; and
moving the agent from the queue state to an on-deck state if there is no thread to provide to the agent.

5. The system of claim 3 wherein the operations further comprise:
receiving a first indication that the first agent associated with the triage state has provided a task to be performed to respond to the user request, the at least one task forming part of the first thread;
awarding the first agent associated with the triage state a first type of credit in response to the first indication;
receiving a second indication that the second agent associated with the queue state has worked on a task forming part of a thread; and
awarding the second agent associated with the queue state a second type of credit, different from the first type of credit, in response to the second indication that the second agent has worked on the task forming part of the thread.

6. A system comprising:
a state management engine configured to associate a first agent with a triage state and a second agent with a queue state and to associate an agent with only one of the triage state and the queue state at one time;
a triage engine configured to receive a user request, to provide a thread associated with the user request to a first agent, and to receive from the first agent at least one task to be performed in order to respond to the user request, the at least one task forming part of the thread;
a queue engine configured to receive the thread from the triage engine, to provide the thread to the second agent, and to receive from the second agent an indication that the second agent has worked on a task forming part of the thread; and
a thread management engine configured to provide a second thread to an agent only if the agent has provided an indication that the agent has stopped working on a first thread.

7. A computer-implemented method comprising:
receiving a user request;
determining that a first agent is in a triage state and that a second agent is in a queue state;
providing a thread associated with the user request to the first agent;
receiving from the first agent at least one task to be performed to respond to the user request, the at least one task forming part of the thread;
providing the thread to the second agent; and
removing a thread from an agent if the agent does not act on the thread according to a specified criteria,
wherein an agent can only be in one of the triage state or the queue state at one time and an agent cannot work on a second thread until after work by the agent on a first thread has stopped.

8. The computer-implemented method of claim 7 wherein removing a thread from an agent if the agent does not act on the thread according to a specified criteria comprises removing a thread from an agent if the agent does not act on the thread within a specified period of time.

9. The computer-implemented method of claim 7 wherein the work on a thread has stopped when the agent working on the thread has indicated completion of the work.

10. The computer-implemented method of claim 7 wherein work on a thread has stopped when the agent working on the thread has requested a pause of work on the thread.

11. The computer-implemented method of claim 7, wherein the method further comprises moving an agent from a first state to a second offline state in response to inactivity by the agent for a specified period of time.

12. The computer-implemented method of claim 7 wherein the method comprises associating each of a plurality of agents with one of a plurality of states and where an agent can only be in one state at one time.

13. The computer-implemented method of claim 12 wherein the plurality of states comprises a triage state, a queue state, an on-deck state, a project state, a lobby state, and a meeting state.

14. The computer-implemented method of claim 7 further comprising:
receiving a work request from an agent;
determining if there is a thread to be provided to the agent in response to the work request; and
moving the agent from the queue state to an on-deck state if there is no thread to provide to the agent.

15. The computer-implemented method of claim 7 further comprising:
receiving a first indication from the first agent associated with the triage state of a first task to be performed to respond to the user request, the task forming part of the thread;
awarding the first agent associated with the triage state a first type of credit in response to the first indication;
receiving a second indication that the second agent associated with the queue state has worked on a second task forming part of the thread; and
awarding the second agent associated with the queue state a second type of credit, different from the first type of credit, in response to the second indication that the second agent has worked on the second task forming part of the thread, wherein the first and second tasks can the same task.

16. The computer-implemented method of claim 15 further comprising:
determining an agent productivity goal; and
determining, for an agent, a percentage of the agent productivity goal reached by the agent.

17. The computer-implemented method of claim 16 wherein determining the agent productivity goal comprises determining a number of credits awarded to an agent, the duration of time in which the agent is associated with a state, the number of tasks worked on by the agent, and the number of threads provided to the agent.

18. The computer-implemented method of claim 7 wherein a primary agent cannot work on a thread that has been provided to a secondary agent while the secondary agent is working on the thread unless the primary agent is a higher priority agent than the secondary agent.

19. The computer-implemented method of claim 18 wherein the primary and secondary agents are the same as the first and second agents, respectively.

20. A computer-implemented method comprising:
receiving a user request;
associating a first agent with a triage state and a second agent with a queue state;
providing a thread associated with the user request to the first agent;
receiving from the first agent at least one task to be performed to respond to the user request, the task forming part of the thread;
providing the thread to the second agent, and
removing a thread from an agent if the agent does not act on a thread according to a specified criteria,
wherein an agent can start work on a second thread at a particular time only after the agent no longer has the ability to work on a first thread.
